(19) United States
(12) Patent Application Publication
(10) Pub. No.: US 2006/0099528 A1
(43) Pub. Date: May 11, 2006

(54) Carrier composition

(75) Inventors: Thomas J. Budny, Penfield, NY (US); Brian S. Giannetto, Livonia, NY (US); Samir Kumar, Pittsford, NY (US); Brian E. Moore, Ontario, NY (US); Bernard A. Kelly, Ontario, NY (US)

Correspondence Address: Richard M. Klein, Esq.;FAY, SHARPE, FAGAN, MINNICH & McKEE, LLP, SEVENTH FLOOR, 1100 SUPERIOR AVENUE, CLEVELAND, OH, 44114-2579, US

(73) Assignee: Xerox Corporation

(21) Appl. No.: 10/982,716

(22) Filed: Nov. 5, 2004

(51) Int. Cl. G03G 9/113

(52) U.S. Cl. 430/111.31; 430/137.13; 430/111.33

(57) ABSTRACT

A carrier particle for an electrostatographic process, and a developer employing such carrier particle, is provided. The carrier particle includes an irregular shaped ferrite core, and a coating applied to the core. The developer includes a carrier particle comprising the irregular shaped ferrite core and a toner. The irregular shaped ferrite cores and developers exhibit reduced toner aging and/or reduced material performance degradation, while exhibiting excellent triboelectric and conductive properties.

### BACKGROUND

The present disclosure relates, in various exemplary embodiments, to the use of an irregular shaped ferrite core in a xerographic carrier composition. It finds particular application in conjunction with the xerographic printing arts, and will be described with particular reference thereto. However, it is to be appreciated that the present exemplary embodiments are also amenable to other like applications.

The electrostatographic process, and particularly the xerographic process, is known. This process involves, for example, the formation of an electrostatic latent image, corresponding to an original image or information data, on the surface of a photoreceptor. This is followed by development of the image with a developer, and subsequent transfer of the developed image to a suitable substrate.

Numerous different types of xerographic imaging processes are known wherein, for example, insulative developer particles or conductive developer particles are selected depending on the development systems used. Moreover, of interest with respect to the aforementioned developer compositions are the appropriate triboelectric charging values associated therewith, as it is these values that may enable continued formation of developed images of high quality and excellent resolution.

In this regard, during the step of development of the electrostatic latent image on the photoreceptor, charged toner particles, sometimes referred to as developers, are placed in contact with the photoreceptor surface or donor roll. The toner particles generally comprise a colorant and a resin binder. Additional components, such as surface additives, charge control additives, waxes, etc., may be further included in the toner particles. The type of resin binder utilized varies with the fusing process, etc.

The toner particles are relatively small, i.e., between about 6 μm to about 11 μm in diameter, and may be finely divided. The toner particles may also be attached or affixed to a carrier particle or bead. When utilized alone, the toner particles generally form a single-component developer. However, when joined with a carrier, the toner particles and carrier form a two-component developer or development system.

The carrier is generally much larger than the toner particles, ranging in size from about 30 μm (microns) to several hundred μms or a thousand μm in diameter. Typically, a large number of toner particles will be attached to each carrier particle. For example, the carrier particles can consist of metal, glass, ferrite, or other materials. Additionally, in many instances, the carrier contains a polymer surface layer to control the toner charge, etc.

During development, the single-component or two-component developers are placed in contact with the photoreceptor surface or donor roll. These may be through various processes such as cascade development, magnetic brush development, electrophoretic development, fur brush development, impression development, etc.

When magnetic brush development is utilized, the development process may be described as insulating or conducting, depending on the conductivity of the developer. This may be determined by the composition and geometry of the carrier particles and the thickness of the polymer coating on the carrier particles.

As a result, carrier particles are comprised, for example, of a generally spherical core, often referred to as the “carrier core”, which may be produced from a variety of materials. The core is typically coated with a resin, such as a polymer or copolymer. The resin may contain a conductive component, such as certain carbon blacks, to, for example, provide carrier particles with more desirable and consistent triboelectric properties. However, including conductive components in the carrier coating may be disadvantageous in some instances. For example, it can be difficult and costly to blend the core and conductive component, and also the conductive component may not fully serve its purposes.

Processes of incorporating conductive material into a carrier coating include the use of electrostatic attraction, mechanical impaction, in situ polymerization, dry blending, thermal fusion and others. These processes often result in only minimal amounts of conductive material being incorporated into the coating. Alternatively, the conductive carrier coatings produced may be too large for effective and efficient use especially with smaller sized carriers.

Additionally, dry blending processes and other mixing procedures to incorporate the carbon black or other conductive material into the polymer coating can be selected. However, to avoid, or minimize transfer of the carbon black from the polymer coating, the amount of carbon black that may be blended may be limited, for example, to 20 percent by weight or less. This limits the conductivity achievable by the resultant conductive polymer. Also, the carbon black from the carrier coating polymer can contaminate the toner resulting in changes in both charging performance and color of the toner, such as for example, a light colored toner, such as yellow.

In addition to the problems associated with loading conductive materials into coating resins, recent efforts to advance carrier particle science have focused on the attainment of conductive coatings for carrier particles to improve development quality, and provide particles that can be recycled and that do not adversely affect the imaging member in any substantial manner. Many coatings can deteriorate rapidly, especially when selected for a continuous xerographic process where the entire coating may separate from the carrier core in the form of chips or flakes causing failure upon impact or abrasive contact with machine parts and other carrier particles. These flakes or chips, which cannot generally be reclaimed from the developer mixture, have an adverse effect on the triboelectric charging characteristics of the carrier particles, thereby providing images with lower resolution in comparison to those compositions wherein the carrier coatings are retained on the surface of the core substrate.

To meet copy quality requirements, hybrid jumping development (HJD) or hybrid scavenging development (HSD) technology is often used. HJD and HSD are collectively referred to herein as “hybrid development systems” or “hybrd development technology.” Both these development systems are extremely hard on the toner and require large amounts of expensive additives to make them work. In hybrid development systems, the toners require large amounts, greater than 3%, of large expensive additives to avoid a loss in development and transfer. The developer housings impact the additives into the toner surface. This increases the toner cohesion and reduces the toners ability to flow. This in turn reduces the toners ability to develop to the donor roll and photoreceptor which results in poor transfer and a fall off in developability. In more conventional systems powder coated atomized steel carriers perform very well with long life even without trickle development. In the hybrid systems, however, trickle is needed and interdocument zone development is used to avoid toner with high age in the housing. Both these are wasteful and dissatisfying to customers.

The conductivity of the developer is primarily driven by the carrier conductivity. To achieve a suitable conductive carrier, electrically conductive carrier cores with partial coatings of electrically insulating polymers to allow a level of exposed carrier cores can be selected. Generally, atomized steel has been used in xerographic application resulting in an irregular highly conductive carrier. Atomized steel can be obtained for less than $1.00 per pound versus $3.00 to $7.00 per pound for ferrites. Ferrites do have an advantage over steel in that ferrites have a lower density than steel. In fact, ferrites may have a density ⅓ that of steel. Compositionally, ferrites are an iron oxide, which is a lower density than pure iron. Use of lower density carriers is desirable because it has been found that they reduce toner aging and also reduce the amount of additives now required in hybrid development technologies.

It is therefore an object to provide a carrier that will contribute to reducing toner aging in a developer. Along these lines it is desirable to provide a carrier that will require fewer additives in certain types of development technologies to reduce additive impaction into the toner. It is also desirable to provide a carrier that enables running a system at higher toner concentrations.

It is also an object to provide a developer package or system that reduces toner aging which may be caused, for example, by additive impaction into the surface of toner molecules.

It is a further object to provide a developer package or system that exhibits reduced material performance degradation. For example, it is desirable to provide a developer that exhibits reduced tribo aging that may be caused by toner impaction into the carrier.

It is still another object to provide a developer with one or more of the above features that exhibits acceptable triboelectric and conductivity properties.

### BRIEF DESCRIPTION

The present exemplary embodiments of this disclosure achieve one or more of the foregoing objects and provide in one aspect a carrier for an electrostatographic process. The carrier comprises an irregular shaped ferrite core and a coating applied thereto. The carrier can then be admixed with a toner composition, such as a toner composition comprised of a colorant and a resin, to produce a developer composition.

In another aspect, a process for preparing carrier particles with substantially stable conductivity parameters is provided. The process includes providing irregular shaped ferrite carrier cores and a coating material, dry mixing the irregular shaped ferrite cores with the coating material so that the coating material adheres to the irregular shaped ferrite cores, heating the mixture of irregular shaped ferrite cores and coating material to a temperature of between about 350° F. and about 450° F., and cooling the coated carrier particles. Subsequently, a developer composition can be produced by admixing the aforementioned carrier particles with a toner composition comprised of a colorant and a polymer resin. These developer compositions are useful in magnetic brush development applications.

In still another aspect of the present exemplary embodiment, a further developer composition is provided. The developer composition comprises a carrier and a toner. The carrier comprises an irregular, non-spherical, shaped ferrite core and a coating material applied to the core. A toner composition comprising a colorant and a resin is admixed into the toner to produce a developer composition. The developer composition is useful in electrostatographic or electrophotographic imaging systems, particularly xerographic imaging processes, to produce high quality printed images.

These and other aspects and/or objects of the disclosure are more particularly described below.

### BRIEF DESCRIPTION OF THE DRAWINGS

The following is a brief description of the drawings, which are presented for the purposes of illustrating the development disclosed herein and not for the purposes of limiting the same.

FIG. 1 is a plot comparing the tribo for an irregular shaped ferrite core and a control core over time as described in Example 2;

FIG. 2 is a plot showing the percentage of cohesion of toner removed from the developer over aging time for both nominal cores and irregular shaped ferrite cores at different toner concentration levels;

FIG. 3 comprises two photomicrographs showing the configuration of the irregular shaped ferrite cores (3A) in comparison to steel cores (3B);

FIGS. 4A-4D show the surface area coverage (SAC) of the irregular shaped ferrite cores (FIGS. 4A-4B) in comparison to that of the steel cores (FIGS. 4C-4D).

### DETAILED DESCRIPTION

The developer composition of the present disclosure includes a toner composition and a carrier particle. The carrier particle comprises an irregular, non-spherical, shaped ferrite core and a coating layer. It has been found that irregular ferrites are advantageous as a carrier core material because they have a lower density than conventional cores. Lower density carriers are less abusive to toner particles in development systems, including hybrid development systems. Because the lower density carriers are less abusive to the toner, the amount of additives used in the toner may be reduced, which increases developer life and increases tribo stability in the developer housing.

Additionally, it has been found that increased surface area provided by the irregular shaped cores allows more toner particles to be charged by a carrier particle. The irregular shape also provides better conductivity when processed as a conductive carrier. It has been further found that the irregular shape of the carrier reduces impaction of toner on the carrier surface providing longer carrier life.

The carrier cores utilized herein also exhibit such characteristics to enable the toner particles to acquire a positive charge or a negative charge; permit desirable flow properties in the developer reservoir present in a xerographic imaging apparatus; permit magnetic brush formation in imaging brush development processes and possess desirable mechanical aging characteristics.

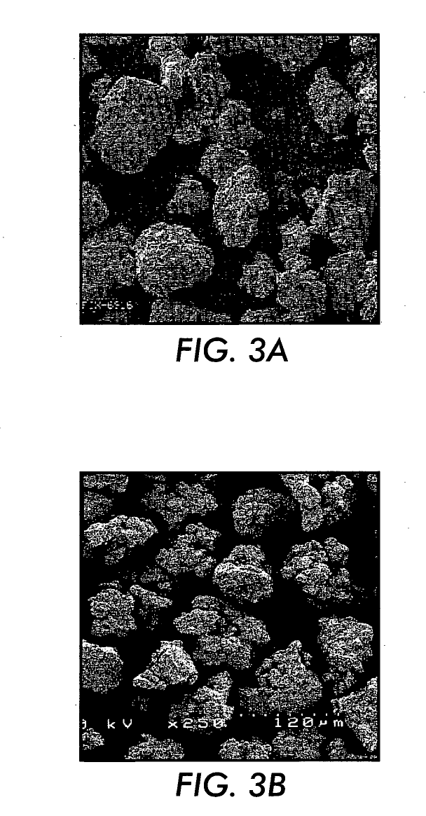

The suitable irregular shaped ferrite particles have an average particle size of from about 40 microns to about 180 microns, including from about 65 microns to about 110 microns. The geometric shape of the particles is similar to that of water atomized iron and alloy cores, being irregular and with numerous peaks and valleys as opposed to spherical shape of xerographic ferrite cores. Examples of such irregular shaped ferrite particles (FIG. 3A) in comparison to steel cores (FIG. 3B) are shown in the photomicrograph set forth in FIGS. 3A-3B.

Additionally, the compositions of the irregular shaped ferrite cores comprise Fe₂O₂, and divalent metal oxides, such as FeO, CaO, MgO, CoO, NiO, etc. Preferably, the cores comprise compositions of the following formula: MnFe₃O₄.

Suitable commercially available irregular ferrites include, but are not limited to those produced by Powdertech International Corp., Chicago, Ill.

Typically for a spherical ferrite, alpha, or the slope of the log of conductivity versus toner concentration, is a high number >4. Conductivity changes rapidly as the toner concentration increases, since the toner effectively blocks carrier to carrier contact and makes the developer more insulative. For very irregular carrier particles, alpha is a low number (i.e., 2 or less) and conductivity does not change with increasing toner concentration since the additional toner can reside in valleys of the carrier surface not blocking carrier to carrier contract.

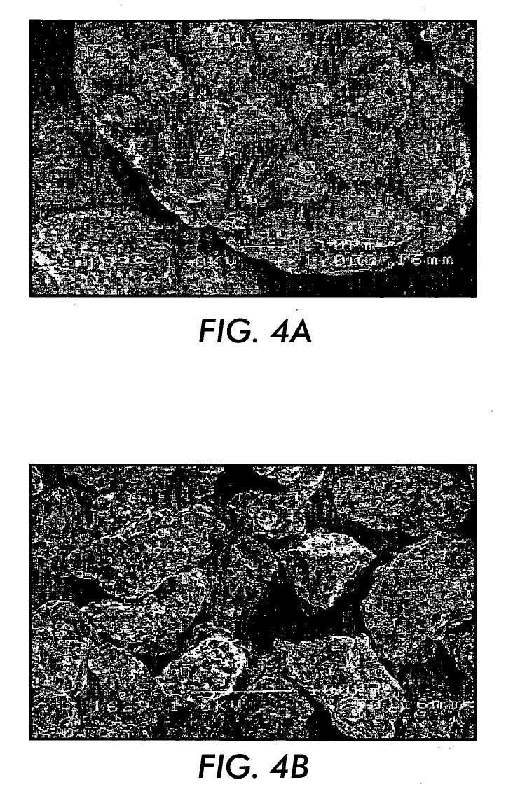

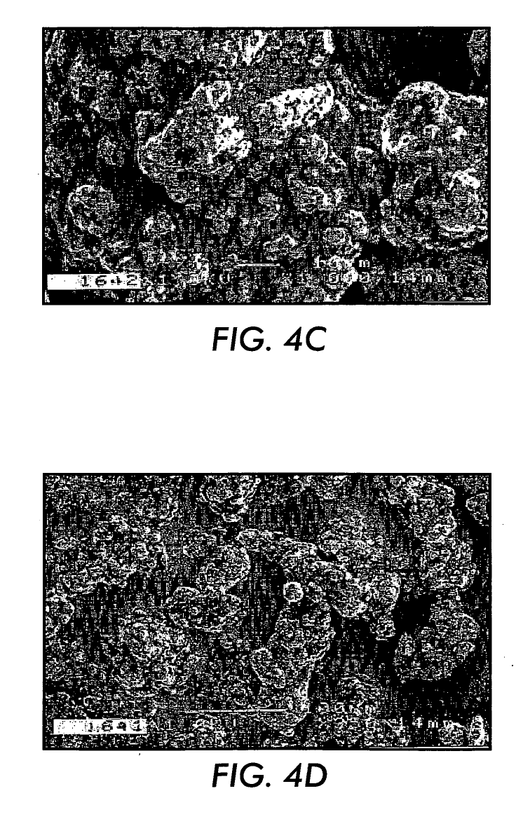

Generally, the irregular ferrite cores of the present exemplary embodiments include a coating applied over the core material. Any suitable coating material known in the art may be applied. The coating may be applied to the core material by any suitable method as is known in the art. Irregular ferrite particles (FIGS. 4A-4B) once coated exhibited the same surface area coverage (SAC) as steel (FIGS. 4C-4D) and are shown in the photomicrographs set forth in FIGS. 4A-4D.

Examples of suitable coating materials include resins such as polystyrene, homopolymers, copolymers, and terpolymers; polymers of halogen containing ethylenes including vinyl fluorides, vinyl chlorides, chlorotrifluoroethylene, a vinyl chloride/chlorotrifluoroethylene copolymer, a vinyl chloride, vinyl acetate copolymer, a chlorotrifluoroethylene polymer, and various known vinyl chloride terpolymers. Acrylic polymers and copolymers typified by polymethylmethacrylate and siloxane polymers are also useful carrier coating, particularly when negative charging toners are desired. Thermosetting resins including epoxy's, acrylics and urethanes can also be used for coatings.

These resins may be used alone or in combination. The carrier coatings are present in an amount of from about 0.1 to about 2.0 percent by weight of the carrier particle, including from about 0.3 to about 1.0 percent by weight of the carrier particle, further including from about 0.3 to about 0.8 percent by weight of the carrier particle, although other amounts are suitable provided that the objectives of the present disclosure are achieved. Coated carrier particles generally may have diameter of, for example, from about 25 to about 1,000 microns, and from about 40 to about 150 microns, thus allowing these particles to possess sufficient density and inertia to avoid adherence to the electrostatic image during the development process.

The irregular ferrite carriers of the present exemplary embodiment may be prepared by any process known in the art. For example, such a process includes mixing irregular shaped ferrite carrier cores and a coating material, dry mixing the irregular shaped ferrite cores with the coating materials so that the coating material adheres to the irregular ferrite cores, heating the mixture of irregular ferrite cores and coating material to a temperature of between about 350° F. and about 450° F., and then cooling the coated carrier particles.

Alternative effective suitable means can be used to apply the polymer mixture coatings to the surface of the carrier particles. Examples of typical means for this purpose include combining the carrier core material, and the mixture of polymers by cascade roll mixing, or tumbling, milling, shaking, electrostatic powder cloud spraying, fluidized bed, electrostatic disc processing, and an electrostatic curtain. Following application of the polymer mixture, heating is initiated to permit flowout of the coating material over the surface of the carrier core. The concentration of the coating material powder particles, as well as the parameters of the heating step, may be selected to enable the formation of a continuous film of the coating material on the surface of the carrier core, or permit only selected areas of the carrier core to be coated. When selected areas of the metal carrier core remain uncoated or exposed, the carrier particles will possess electrically conductive properties when the core material comprises a metal. The aforementioned conductivities can include various suitable values. Generally, however, this conductivity is from about 10⁻⁹ to about 10⁻¹⁷ as measured, for example, across a 0.1 inch magnetic brush at an applied potential of 30 volts; and wherein the coating coverage encompasses from about 10 percent to about 100 percent of the carrier core.

The coated carrier cores (or carrier particles) can then be mixed with a toner composition to produce a developer composition. The toner composition comprises a colorant, a resin and/or various internal and/or external charge control agents. Magnetite Fe₃O₄ can also be added to create a Magnetic Ink Character Recognition (MICR) toner.

Numerous well known suitable pigments or dyes can be selected as the colorant for the toner particles including, for example for black toners, carbon black, nigrosine dye, lamp black, iron oxides, magnetites, and mixtures thereof. The pigment, which is preferably carbon black, should be present in a sufficient amount to render the toner composition highly colored. Thus, the pigment particles or dyes are present in amounts of from about 3 percent by weight to about 20 percent by weight, based on the total weight of the toner composition, however, lesser or greater amounts of pigment particles can be selected providing the objectives of the present disclosure are achieved.

When the pigment particles are comprised of magnetites, which are a mixture of iron oxides (FeO, Fe₂O₃, Fe₃O₄) including those commercially available as Mapico Black, they are present in the toner composition in an amount of from about 10 percent by weight to about 70 percent by weight, and preferably in an amount of from about 20 percent by weight to about 50 percent by weight.

The resin particles are present in a sufficient, but effective amount, thus when 10 percent by weight of pigment, or colorant such as carbon black is contained therein, about 90 percent by weight of resin material is selected. Generally, however, providing the objectives of the present disclosure are achieved, the toner composition is comprised of from about 85 percent to about 97 percent by weight of toner resin particles, and from about 3 percent by weight to about 15 percent by weight of pigment particles such as carbon black.

Also encompassed within the scope of the present disclosure are colored toner compositions comprised of toner resin particles, carrier particles and as pigments or colorants, magenta, cyan and/or yellow particles, as well as mixtures thereof. More specifically, illustrative examples of magenta materials that may be selected as pigments include 1,9-dimethyl-substituted quinacridone and anthraquinone dye identified in the color index as CI 60720, CI Dispersed Red 15, a diazo dye identified in the color index as CI 26050, CI Solvent Red 19, and the like. Examples of cyan materials that may be used as pigments include copper tetra-4(octaecyl sulfonamido) phthalocyanine, X-copper phthalocyanine pigment listed in the color index as CI 74160, CI Pigment Blue, and Anthrathrene Blue, identified in the color index as CI 69810, Special Blue X-2137, and the like; while illustrative examples of yellow pigments that may be selected are diarylide yellow 3,3-dichlorobenzidene acetoacetanilides, a monoazo pigment identified in the color index as CI 12700, Cl Solvent Yellow 16, a nitrophenyl amine sulfonamide identified in the color index as Foron Yellow SE/GLN, Cl Dispersed Yellow 33, 2,5-dimethoxy-4-sulfonanilide phenylazo-4′-chloro-2,5-dimethoxy aceto-acetanilide, permanent yellow FGL, and the like. These pigments are generally present in the toner composition an amount of from about 1 weight percent to about 15 weight percent based on the weight of the toner resin particles.

For further enhancing the charging characteristics of the developer compositions described herein, and as optional components there can be incorporated herein charge enhancing additives inclusive of alkyl pyridinium halides, reference U.S. Pat. No. 4,298,672, the disclosure of which is totally incorporated herein by reference; organic sulfate or sulfonate compositions, reference U.S. Pat. No. 4,338,390, the disclosure of which is totally incorporated herein by reference; distearyl dimethyl ammonium sulfate; copending application Ser. No. 645,660, entitled Toner Compositions with Ammonium Sulfate Charge Enhancing Additives, the disclosure of which is totally incorporated herein by reference; and other similar known charge enhancing additives. These additives are usually incorporated into the toner in an amount of from about 0.1 percent by weight to about 20 percent by weight.

Illustrative examples of finely divided toner resins include polyamides, epoxies, polyurethanes, diolefins, vinyl resins and polymeric esterification products of a dicarboxylic acid and a diol comprising a diphenol. Specific vinyl monomers that can be used are styrene, p-chlorostyrene vinyl naphthalene, unsaturated mono-olefins such as ethylene, propylene, butylene and isobutylene; vinyl halides such as vinyl chloride, vinyl bromide, vinyl fluoride, vinyl acetate, vinyl propionate, vinyl benzoate, and vinyl butyrate; vinyl esters like the esters of monocarboxylic acids including methyl acrylate, ethyl acrylate, n-butylacrylate, isobutyl acrylate, dodecyl acrylate, n-octyl acrylate, 2-chloroethyl acrylate, phenyl acrylate, methylalphachloracrylate, methyl methacrylate, ethyl methacrylate, and butyl methacrylate; acrylonitrile, methacrylonitrile, acrylamide, vinyl ethers, inclusive of vinyl methyl ether, vinyl isobutyl ether, and vinyl ethyl ether, vinyl ketones inclusive of vinyl methyl ketone, vinyl hexyl ketone and methyl isopropenyl ketone; vinylidene halides such as vinylidene chloride, and vinylidene chlorofluoride; N-vinyl indole, N-vinyl pyrrolidene; styrene butadiene copolymers; mixtures thereof; and other similar substances.

As one preferred toner resin there can be selected the esterification products of a dicarboxylic acid and a diol comprising a diphenol, reference U.S. Pat. No. 3,590,000 the disclosure of which is totally incorporated herein by reference. Other preferred toner resins include styrene/methacrylate copolymers; styrene/butadiene copolymers; polyester resins obtained from the reaction of bisphenol A and propylene oxide; and branched polyester resins resulting from the reaction of dimethylterephthalate, 1,3-butanediol, 1,2-propanediol and pentaerthriol.

Generally, from about 1 part to about 5 parts by weight of toner particles are mixed with from about 10 to about 300 parts by weight of the carrier particles prepared in accordance with the process of the present disclosure.

The toner composition of the present disclosure can be prepared by a number of known methods including melt blending the toner resin particles, and pigment particles or colorants of the present disclosure followed by mechanical attrition. Other methods include those well known in the art such as spray drying, melt dispersion, dispersion polymerization and suspension polymerization. In one dispersion polymerization method, a solvent dispersion of the resin particles and the pigment particles are spray dried under controlled conditions to result in the desired product.

Also, the toner and developer compositions of the present disclosure may be selected for use in electrostatographic imaging processes containing therein conventional photoreceptors, including inorganic and organic photoreceptor imaging members. Examples of imaging members are selenium, selenium alloys, and selenium or selenium alloys containing therein additives or dopants such as halogens. Furthermore, there may be selected organic photoreceptors illustrative examples of which include layered photoresponsive devices comprised of transport layers and photogenerating layers, reference U.S. Pat. No. 4,265,990, the disclosure of which is totally incorporated herein by reference, and other similar layered photoresponsive devices. Examples of generating layers are trigonal selenium, metal phthalocyanines, metal free phthalocyanines and vanadyl phthalocyanines. As charge transport molecules there can be selected the aryl diamines disclosed in the '990 patent. Also, there can be selected as photogenerating pigments, squaraine compounds, thiapyrillium materials, and the like. These layered members are conventionally charged negatively thus requiring a positively charged toner. Other photoresponsive devices useful in the present disclosure include polyvinylcarbazole 4-dimethylaminobenzylidene, benzhydrazide; 2-benzylidene-aminocarbazole, 4-dimethamino-benzylidene, (2-nitrobenzylidene)-p-bromoaniline; 2,4-diphenyl-quinazoline; 1,2,4-triazine; 1,5-diphenyl-3-methyl pyrazoline 2-(4′-dimethylaminophenyl)-benzoaxzole; 3-aminocarbazole, polyvinyl carbazole-trinitrofluorenone charge transfer complex; and mixtures thereof. Moreover, the developer compositions of the present disclosure are particularly useful in electrostatographic imaging processes and apparatuses wherein there is selected a moving transporting means and a moving charging means; and wherein there is selected a deflected flexible layered imaging member, reference U.S. Pat. Nos. 4,394,429 and 4,368,970, the disclosures of which are totally incorporated herein by reference.

The coated carrier cores can then be mixed with a toner composition to produce a developer composition. The two-component developer materials of the present exemplary embodiment, which include the irregular shaped ferrite cores and a toner, are used in the first step of the development process. During the development process, toner particles are attached to a latent image forming a toner powder image on the photoconductive surface. The first step can also be to transfer the toner to a donor roll, then the toner is transferred to a powder cloud, and finally it is transferred to the latent image forming a powder image on the photoconductive surface_(Hybrid Scavengeless Development (HSD) system) or the toner is directly transferred from the donor roll to the latent image forming a powder image on the photoconductive surface_(Hybrid Jumping gap Development (HJD) system). The toner powder image is subsequently transferred to a copy sheet. Finally, the toner powder image is heated to permanently fuse it to the copy sheet in image configuration. The developer of the present exemplary embodiment may be used in any development system or process known in the art.

The present exemplary embodiments are further understood in view of the following examples. The examples are intended to illustrate and not limit the scope of the present disclosure.

### EXAMPLES

### Example I

Experiments were performed with toner particles on a carrier comprising an irregular shaped ferrite core to improved tribo stability, i.e., decreasing tribo of the developer as the developer ages.

As described herein, it has been found that the use of an irregular shaped ferrite carrier core increases developer life and contributes to a developer materials package that has increased tribo stability in the developer housing. Developers utilizing conventional carrier cores aged five hours in a developer housing with zero throughputs show changes with time. From SEM and XPS analysis of loose additives (˜15% Silica, ˜12% Titania, & ˜5% ZnSt surface area coverage) attach to high charge regions of conventional carrier beads within a relatively low period of time in the developer housing. With time, these additives impact into the polymer coating. Additionally, toner impaction increases from 0.2 to 1.5% by weight. Developer properties are controlled by additive movement, additive impaction and toner impaction. By decreasing the density of the carrier, the intensity of the physical interaction between carrier and toner is decreased, thereby reducing the rate at which additives and toner impact into the polymer coating of the carrier surface. Testing with irregular ferrite cores has shown the carriers aged in the developer housing had a tribo drop-off rate that is less pronounced than that of nominal materials.

Additionally, it has been found that irregular shaped ferrite core produces improved conductivity over spherically shaped ferrite core. The irregular shaped ferrite's conductivity is two orders of magnitude larger than spherically shaped ferrite (10⁻⁹ versus 10⁻¹¹ Mho-cm for spherical ferrites).

Table 1 compares various properties of some irregular shaped ferrite cores and a nominal atomized steel core. The irregular ferrite cores are similar in shape to atomized steel but have a lower density.

TABLE 1
Core Properties for Nominal and Irregular Shaped Ferrites

| | | Ferrites | |
|---|---|---|---|
| | Iron | Irregular shaped | Irregular shaped |
| | Ancorsteel | ferrite | ferrite |
| Core Properties | (77 μm) | (61 μm) | (90 μm) |
| Tribo (μ C/g) | 33.2 | 16.9 | 23.8 |
| Size Vol (0.5) (μm) | 80.9 | 60 | 90.4 |
| Fines (% <38 μm) | 1.5 | 8.8 | 3.81 |
| Conductivity | 7.9E-08 | 1.5E-09 | 1.63E-08 |
| (mho/cm) | | | |
| (10 volt) | | | |
| Voltage Breakdown | 43.8 | 60.8 | 38 |
| (volts) | | | |
| Bulk Density (g/cc) | 2.8 | 2.1 | 2.1 |
| True Density (g/cc) | 7.9 | 5.04 | 4.89 |
| Saturization. Mag. | 194 | 91 | 92 |
| (Emu/g) | | | |
| BET (cm²/g) | 349 | 767 | 268 |

From the above table it is apparent that the bulk & true densities of the ferrite core is lower than that of iron core while the conductivity is comparable.

TABLE 2
Carrier Properties for Iron Carrier and
Irregular Shaped Ferrite Carrier.

| carrier | Tribo | Conductivity | Voltage Breakdown |
|---|---|---|---|
| Irregular ferrite | 40.5 | 1.37E−09 | 110.8 |
| iron | 45.17 | 1.51E−10 | 119.2 |

### Example II

In another study, various properties of a developer employing an irregular shaped ferrite carrier were determined. The housing contained 3.45 kg of a black developer and was replenished with a 2:1 ratio of a nominal black toner. The material was tested with 850 VAC amplitude across the wires. This was conducted over 15 hours at 20%, 50%, and 2% area coverage, at the developer housing speed equivalent to 100 ppm using the mentioned replenisher for throughput. The toner concentration of the developer was controlled near 4.5%. This was conducted at 70° F. and 50% relative humidity. An iron carrier made into a developer with the same black toner and was tested under identical conditions as a control.

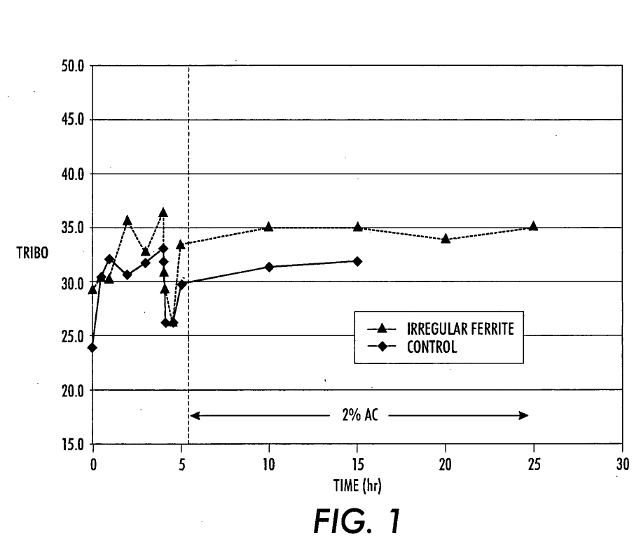

FIG. 1 shows a plot of the tribo for the test and control toners over time at 2% area coverage. As shown in FIG. 1, the tribo of the test toner was found to be in the range of 24-33 μC/g, which was fairly close to the range for the control toner. The tribo range for the control toner was 26-36 μC/g. The maximum delta between the materials was approximately 5 μC/g which is inside of the noise range for this test. Hence the two materials have the same charging characteristics.

A known measure of triboelectric charging values is Aₜ which is defined as: Aₜ=(triboelectric charging value)×(TC+K). The term “TC” represents toner concentration. The value “K” is a value ranging from 0 to about 10, and preferably 1. The value “K” is a function of the toner and carrier sizes and is generally constant for fixed toner and carrier sizes. Both Aₜ and the triboelectric charging value may be positive or negative, depending upon the polarity of the toner. The triboelectric value Aₜ is discussed, for example, in E. J. Gutman, et al., Triboelectric Properties of Two-Component Developers for Xerography, Journal of Imaging Science and Technology, Vol. 36, No. 4, pp. 335-349 (July-August 1992), the disclosure of which is totally incorporated by reference.

It is believed that Aₜ substantially reduces the influence of toner concentration on triboelectric charging values. Because Aₜ is directly correlated to triboelectric charging values as reflected in the above equation, it is understood that generally any discussion of Aₜ of triboelectric values is applicable to the other. For example, discussion that embodiments of the present disclosure may result in an increase in the magnitude of Aₜ of developers also suggests an increase in the magnitude of the triboelectric charging values; but for xerographic development systems operating at constant triboelectric values, an increase in the magnitude of Aₜ will be reflected in an increase in toner concentration. Aₜ is in units of 10^{31 2} micro-Coul/g. Triboelectric charging values may be determined by any suitable method including the known Faraday Cage technique.

The Aₜ of the test material range from 136 to 193. While the control had an Aₜ of 169 to 206 for the first half of the study. The delta between the materials was approximately around 33 points. Again this delta is smaller than the expected noise in the measurement technique and shows that the materials have equivalent charging characteristics.

Additionally, it was noted that the irregular ferrite carrier exhibited lower toner impaction as compared to the iron carrier. Lowering carrier impaction reduces carrier aging and increases the life of the developer. Thus, this example has shown that the use of irregular ferrite carrier cores can reduce developer aging while providing satisfactory triboelectric properties as compared to conventional cores.

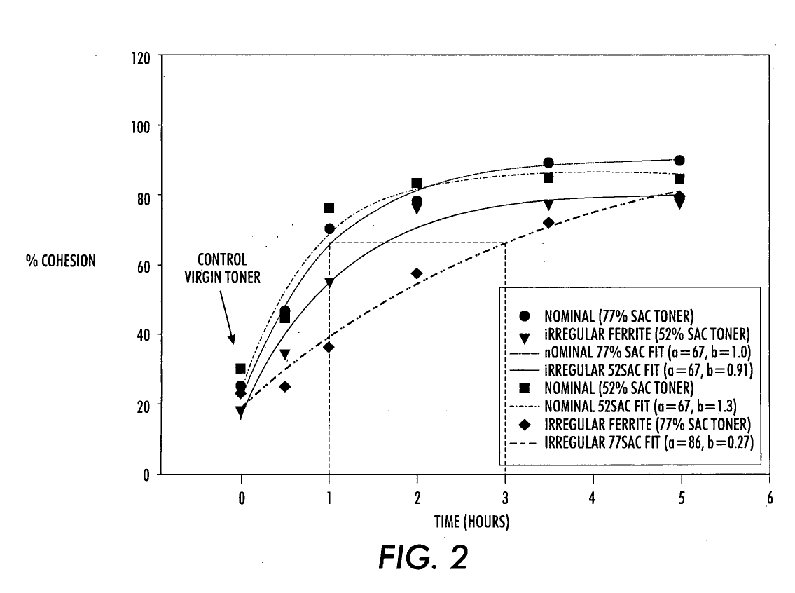

With reference to FIG. 2, cohesion data is shown for the toners removed from the developers of both the nominal carriers and irregular ferrite carriers at various toner concentrations. FIG. 2 shows the percentage of toner cohesion over time. The fit for cohesion is represented by the equation Y=Y₀+a(1−e^{-bx}). In the equation, Y₀=the 0 time value, A+Y₀=the asymptote, and b drives the rate. The entire term likely describes additive embedding into the toner surface. As shown in FIG. 2, there is lowertoner cohesion in systems using irregular shaped ferrite carriers. Additionally, the rate of toner cohesion or “additive embedding” is also lower in systems using irregular shaped ferrite carriers. Lower toner cohesion means that there is reduced toner aging in the system. Reduced toner aging allows greater toner flow in the system for longer periods of time. This may improve or, at least, not result in a decrease in developability.

Consequently, it is beneficial to use an irregularly shaped ferrite carrier core. The reasons for this include, but are not limited to: (i) lower density than steel less toner aging—demonstrated lower cohesion; (ii) irregular ferrite cores enable running at higher TC's, which reduce toner aging; (iii) irregular ferrite cores can be made with sharper edges to improve donor roll filming; (iv) softer magnetic brush applications are possible, which reduces the aging of the toner; and (v) tribo appears very stable in fixture tests.

### Carrier Example III

### Preparation of 0.4% (by wt.) of Polymethylmethacrylate Coated Carrier on Irregular Shaped Ferrite Core

There was prepared by mixing in a Munson style blender (Model #MX-1, obtained from Munson Machinery Company Inc., Utica, N.Y.) a core/polymer premix by combining 181.4 grams of polymethylmethacrylate (MP-116 available commercially from Soken Chemical & Engineering Co. Ltd., Tokyo, Japan). with 100 pounds of 90 micron volume median diameter irregular shaped ferrite core (obtained from Powdertech—core size determined in this and all following carrier examples by a standard laser diffraction technique). The mixing was accomplished at 27.5 rpm for a period of 30 minutes. There resulted uniformly distributed and electrostatically attached polymer on the steel core as determined by visual observation.

The resulting mixture was then processed in a seven inch I.D. rotary furnace (obtained from Harper International Inc., Lancaster N.Y.) under the conditions of 6 rpm, feedrate of 475 grams/minute and furnace angle of 0.6 degree. The conditions presented (rpm, feedrate and angle) are some of the primary factors that drive the residence time and volume loading which are the desired parameters for fusing the coating to the carrier core. Residence time is calculated as the quotient of the weight of the core/polymer mixture in the muffle section (heated section) of the kiln and the feedrate of the materials. The resulting residence time of the materials at the above stated setpoints was 16.4 minutes. The volume loading of the kiln at the above stated setpoints was 5.15 percent of the total volume of the kiln. The peak bed temperature of the materials under these conditions was 441° F., thereby causing the polymer to melt and fuse to the core. This produced a continuous uniform polymer coating on the core. The carrier powder coating process used is described, for example, in U.S. Pat. Nos. 4,935,326; 5,015,550 4,937,166; 5,002,846 and 5,213,936, the disclosures of which are totally incorporated herein by reference.

The final product was comprised of a carrier core with a total of 0.4 percent by weight of poly(methyl methacrylate) on the surface. The weight percent of this carrier was determined in this and all following carrier examples by dividing the difference between the weights of the fused carrier and the carrier core by the weight of the fused carrier.

A developer composition was then prepared in this and all following carrier examples by mixing 100 grams of the above prepared carrier with 4.5 grams of an 8.45 micron volume median diameter (volume average diameter) Cyan toner. Cyan toner composition was comprised of Polytone-C Cyan 15:3 Pigment, a partially crosslinked polyester resin obtained by the reactive extrusion of a linear bisphenol-A propylene oxide fumarate polymer. The toner composition contained as external surface additives 1.93 percent by weight of hydrophobic 40 nanometer size titania, 3.36 percent by weight of 30 nanometer size hydrophobic silica, 0.1 percent by weight of 12 nanometer size hydrophobic silica and 0.5 weight percent of zinc stearate. The final toner composition had a melt flow index of 9. This developer was conditioned for 1 hour at 50 percent RH and 70° F. The resulting developer was shaken on a paint shaker at 715 rpm in a 4 ounce jar and a 0.30 gram sample was removed after 20 minutes. Thereafter, the triboelectric charge on the carrier particles was determined by the known Faraday Cage process, and there was measured on the carrier a negative charge of 34.8 microcoulombs per gram. Further, the conductivity of the carrier as determined by forming a 0.1 inch magnetic brush of the carrier particles, and measuring the conductivity by imposing a 30 volt potential across the brush was 3.57×10⁻¹⁰ (ohm-cm)⁻¹. Therefore, these carrier particles were conductive.

### Carrier Example IV

### Preparation of 1.0% (by wt.) of Polymethylmethacrylate Coated Carrier on Irregular Shaped Ferrite Core

A core/polymer premix was prepared as described in Carrier Example III by combining 453.6 grams of polymethylmethacrylate (MP-116) with 100 pounds of 90 micron volume median diameter irregular shaped ferrite core.

Subsequently, the resulting mixture was then processed in a three-inch I.D. rotary furnace (obtained from Harper International Inc., Lancaster N.Y.) under the conditions of 6 rpm, feedrate of 475 grams/minute and furnace angle of 0.6 degree. The resulting residence time of the materials at the above stated setpoints was 27.8 minutes. The volume loading of the kiln at the above stated setpoints was 9.62 percent of the total volume of the kiln. The peak bed temperature of the materials under these conditions was 438° F., thereby causing the polymer to melt and fuse to the core. The final product was comprised of a carrier core with a total of 1.0 percent by weight of poly(methyl methacrylate) on the surface.

A developer composition was then prepared as described in Carrier Example III. Thereafter, the triboelectric charge on the carrier particles was determined by the known Faraday Cage process, and there was measured on the carrier a negative charge of 37 microcoulombs per gram. Further, the conductivity of the carrier as determined by forming a 0.1 inch magnetic brush of the carrier particles, and measuring the conductivity by imposing a 30 volt potential across the brush was 7.59×10⁻¹⁰ (ohm-cm)⁻¹.

1. A carrier composition for an electrostatographic process, the carrier composition comprising:
an irregular shaped ferrite core; and
a coating applied to said irregular shaped ferrite core.

2. A carrier composition according to claim 1, wherein the coating is present in an amount of about 0.4% by weight to about 1.0% by weight of the carrier.

3. A carrier composition according to claim 1, wherein the coating is present in an amount of about 0.4% by weight to about 0.8% by weight of the carrier.

4. A carrier composition according to claim 1, wherein the irregular shaped ferrite core comprises a metal oxide selected from the group of oxides consisting of iron, calcium, magnesium, lithium, manganese, and titanium.

5. A process for preparing a carrier particle with a substantially stable conductivity parameter, the process comprising:
providing an irregular shaped ferrite carrier core and a coating material;
dry mixing the irregular shaped ferrite core with the coating material so that the coating material adheres to the irregular shaped ferrite core;
heating the mixture of irregular shaped ferrite core and coating material to a temperature of from about 350° F. to about 450° F.; and
cooling the coated carrier particle.

6. The process according to claim 5, wherein the mixture of the irregular shaped ferrite core and coating material is heated to a temperature of about 450° F.

7. A developer composition comprising:
a carrier particle comprising i) an irregular shaped ferrite core and ii) a coating material applied to said irregular ferrite core; and,
a toner composition.

8. A developer composition according to claim 7, wherein the coating material is present in an amount of from about 0.4% by weight to 1.0% by weight of the carrier particle.

9. A developer composition according to claim 7, wherein the coating material is present in an amount of from about 0.4% by weight to about 0.8% by weight of the carrier particle.

10. A developer composition according to claim 7, wherein the irregular shaped ferrite core comprises a metal oxide selected from the group consisting of iron oxide, calcium oxide, magnesium oxide, lithium oxide, manganese oxide and titanium oxide.

11. A process for forming a display, said process comprising:
generating an electrostatic latent image on an imaging member; and,
developing the latent image by contacting the imaging member with a developer composition, wherein the developer composition comprises i) a carrier particle comprising a irregular shaped ferrite core and a coating material; and, ii) at least one toner particle attached to the carrier particle.

12. The process of claim 11, wherein the toner particle is present in the amount of about 2 percent to about 6 percent by weight of the developer composition.

13. The process of claim 11, wherein the coating material includes a polymer to control toner charge.

14. The process of claim 11, wherein the toner particle includes a colorant in a resin binder.

15. The process of claim 11, wherein the toner particle also includes an additive selected from the group consisting of a charge control agent, surface additives to control flow or clearing, and a wax to control toner particle adhesion.

16. The process of claim 11, wherein the irregular shaped ferrite core comprises a metal oxide selected from the group of iron oxide, calcium oxide, magnesium oxide, lithium oxide, manganese oxide and titanium oxide.
